(19) United States
(12) Patent Application Publication
(10) Pub. No.: US 2016/0042725 A1
(43) Pub. Date: Feb. 11, 2016

(54) SNARE STRUCTURE FOR A DRUM

(71) Applicant: D. B. MUSICAL INSTRUMENT CO., LTD., Taichung City (TW)

(72) Inventor: Tony HUANG, Taichung City (TW)

(21) Appl. No.: 14/455,903

(22) Filed: Aug. 9, 2014

(51) Int. Cl. G10D 13/02

(52) U.S. Cl. CPC G10D 13/025

(57) ABSTRACT

A snare structure for a drum includes: a plurality of snare wires, a first fixing member and a second fixing member. Each of the snare wires includes a first end, an opposite second end, and a wire portion between the first and second ends. The first fixing member includes first fixing portion for fixing the first end of each of the snare wires, and a first covering portion which is formed on the first fixing portion by injection molding to cover the first end, the first covering portion includes a flat first end surface. The second fixing member includes a second fixing portion for fixing the second end of each of the snare wires, and a second covering portion which is formed on the second fixing portion by injection molding to cover the second end, and the second covering portion includes a flat second end surface.

### BACKGROUND OF THE INVENTION

1. Field of the Invention

The present invention relates to a snare, and more particularly to a snare structure for a drum.

2. Description of the Prior Art

FIG. 1 shows a conventional snare structure for a drum, wherein the drum 11 includes an upper surface (striking surface) 111 and an opposite lower surface 112. The snare 12 includes two fixing members 121 and a plurality of spiral snare wires 122 disposed between the fixing members 121. The two fixing members 121 are fixed to the drum 11, and the snare wires 122 are located adjacent to or abutted closely against the lower surface 112. Adjusting the tension of the snare wires 122 can control the sound generated when the lower surface 112 strikes the snare wires 122, so as to adjust the sound of the drum. For example, the tighter the tension of the snare wires 122, the higher the tone of the drum, and contrariwise, the loose the snare wires 122, the lower the tone of the drum.

As shown in FIG. 2, the snare wires 122 are welded to the fixing members 121, which suffers from the following shortcomings:

First of all, welding process will produce poisonous gas. In addition to that, hydrochloric acid always needs to be dropped at the welded portion, during the welding process, to melt the contact surfaces of the fixing members and the snare wires, so that the snare wires can be welded more firmly to the fixing members. Then, the acid solution residue must be washed away with water in order to prevent the erosion of the fixing members and the snare wires.

On the other hand, the drum is likely to be scratched. When the fixing members 121 and snare wires 122 are welded together, a rough and uneven surface will be produced at the contact portion 13 between the fixing members 121 and the snare wires 122 and is likely to scratch the lower surface 112 of the drum, when the snare 12 is fixed to the drum 11.

The present invention has arisen to mitigate and/or obviate the afore-described disadvantages.

### SUMMARY OF THE INVENTION

The primary objective of the present invention is to provide a snare structure for a drum, which prevent the generation of poisonous gas during the manufacturing of the snare.

Another objective of the present invention is to provide a snare structure for a drum, which can prevent the scratch of the lower surface of the scratch, when the snare is assembled to the drum.

To achieve the above objective, a snare structure for a drum in accordance with the present invention comprises: a plurality of snare wires each including a first end, an opposite second end, and a wire portion between the first and second ends; a first fixing member including a first fixing portion for fixing the first end of each of the snare wires, and a first covering portion which is formed on the first fixing portion by injection molding to cover the first end, the first covering portion including a flat first end surface; and a second fixing member including a second fixing portion for fixing the second end of each of the snare wires, and a second covering portion which is formed on the second fixing portion by injection molding to cover the second end, and the second covering portion including a flat second end surface.

Preferably, a vertical distance from the first end surface of the first fixing member to the first fixing portion is smaller than a diameter of the first end of each of the snare wires, and a vertical distance from the second end surface of the second fixing member to the second fixing portion is smaller than a diameter of the second end of each of the snare wires.

Preferably, a vertical distance from the first end surface of the first fixing member to the first fixing portion is larger than a diameter of the first end of each of the snare wires, and a vertical distance from the second end surface of the second fixing member to the second fixing portion is larger than a diameter of the second end of each of the snare wires.

### BRIEF DESCRIPTION OF THE DRAWINGS

FIG. 1 is a perspective view of a conventional drum with a snare;

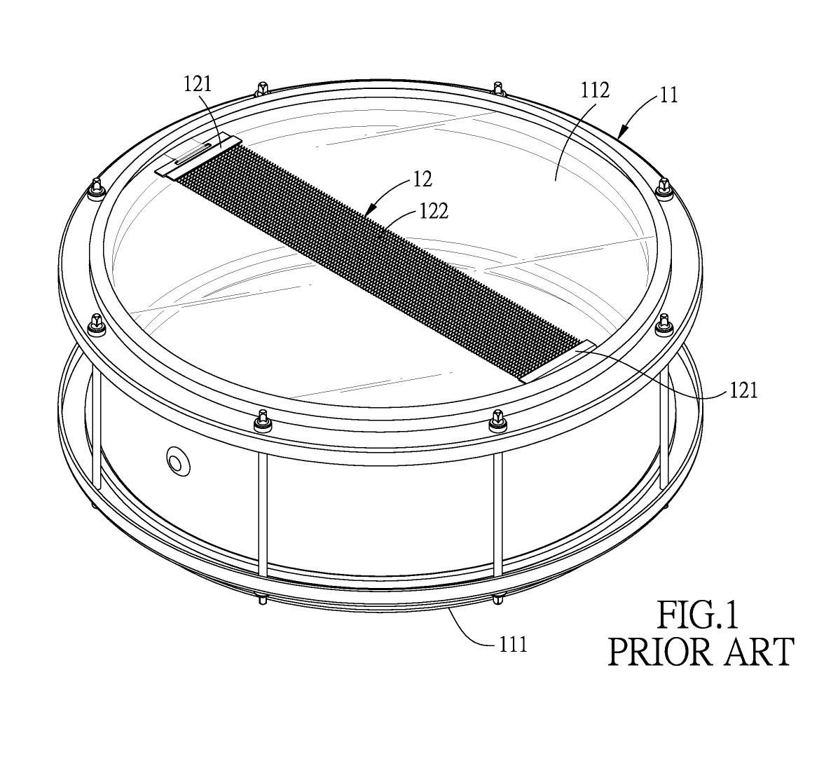

FIG. 2 is a cross sectional view showing that the conventional snare is assembled on the drum;

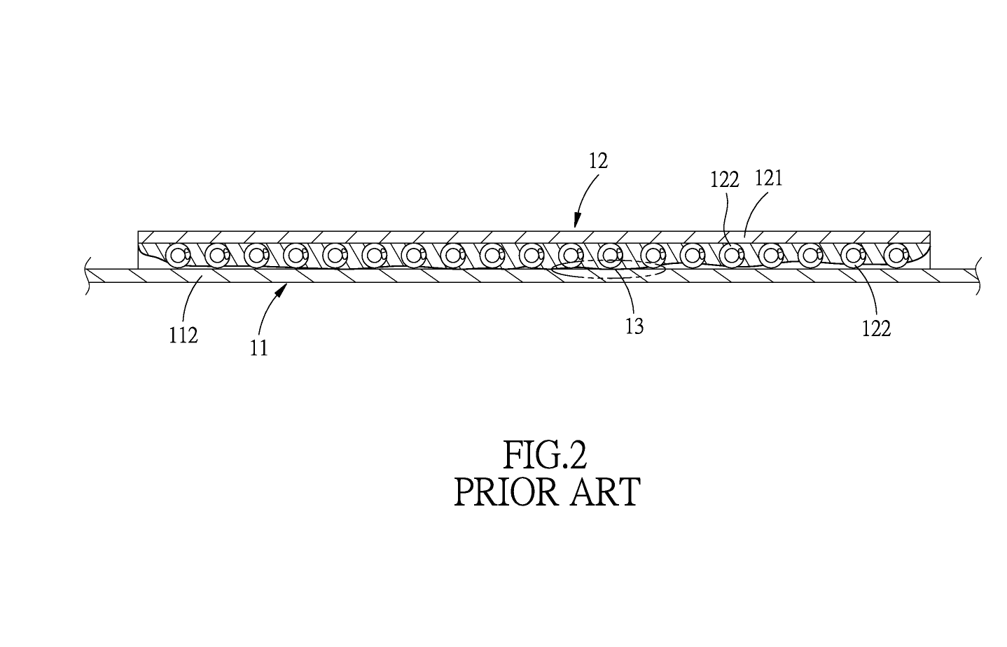

FIG. 3 is a perspective view of a snare structure for a drum in accordance with a first embodiment of the present invention;

FIG. 4 is an enlarged view of the snare structure for the drum in accordance with the first embodiment of the present invention;

FIG. 5 is another enlarged view of the structure for the drum in accordance with the first embodiment of the present invention;

FIG. 6 is an enlarged view of the snare structure for the drum in accordance with a second embodiment of the present invention;

FIG. 7 is another enlarged view of the structure for the drum in accordance with the second embodiment of the present invention; and

FIG. 8 is another magnified view of the structure for the drum in accordance with the second embodiment of the present invention, showing that the snare wires are fixed to the first fixing member (second fixing member) in another manner.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

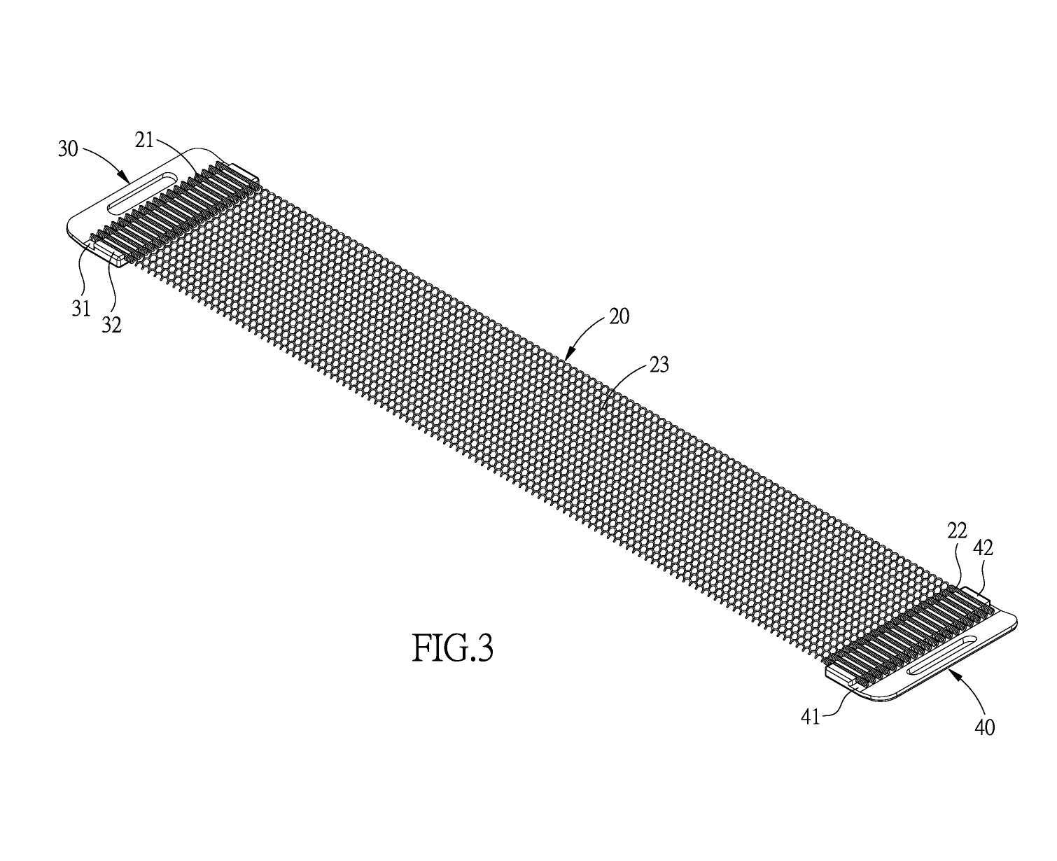

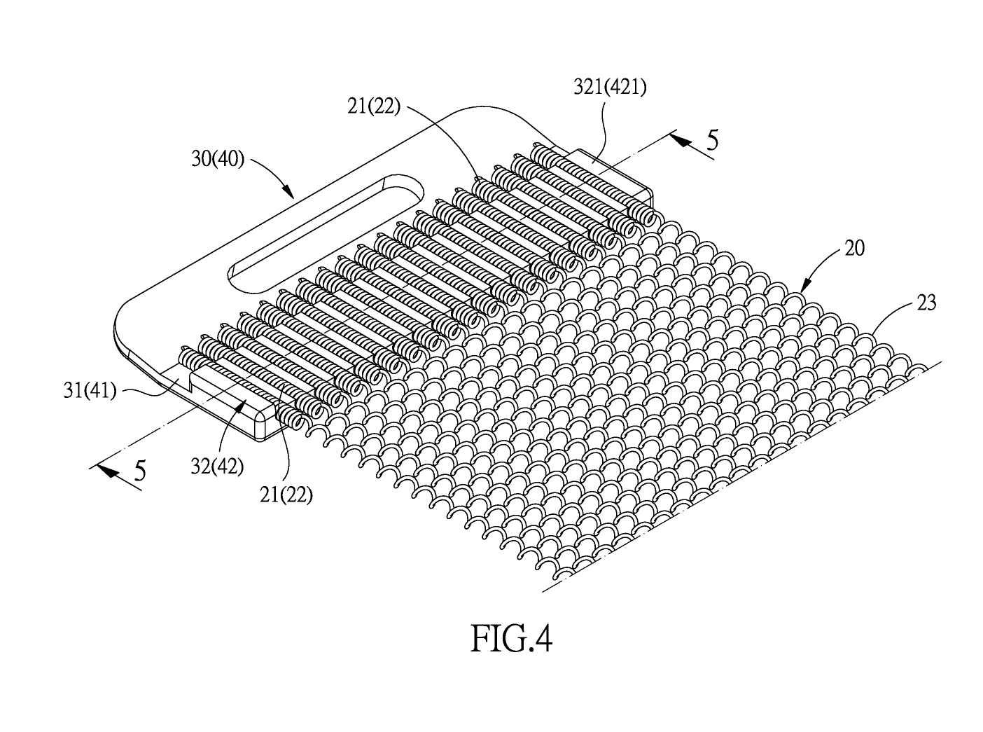

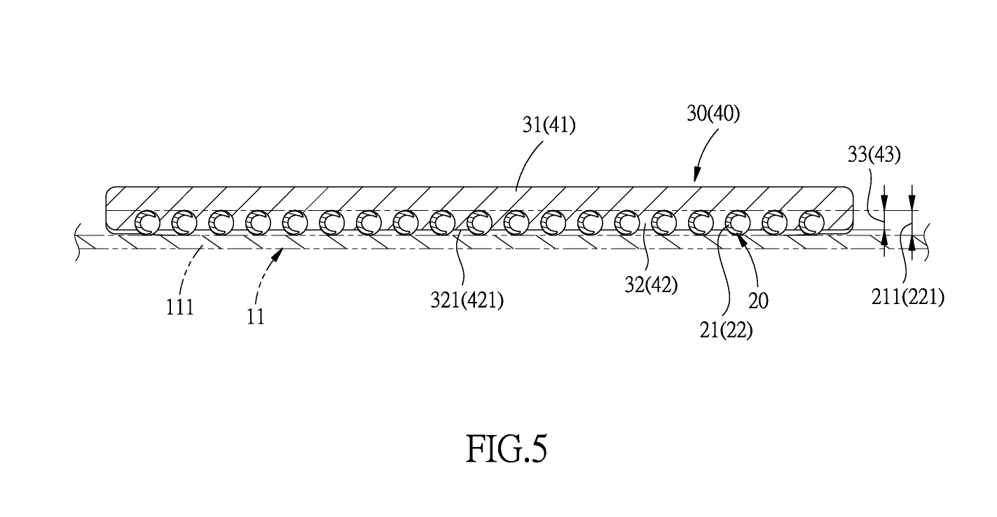

Referring to FIGS. 3-5, a snare structure for a drum in accordance with a first embodiment of the present invention comprises: a plurality of snare wires 20, a first fixing member 30 and a second fixing member 40.

The snare wires 20 each include a first end 21, an opposite second end 22, and a wire portion 23 between the first and second ends 21, 22. In this embodiment, each of the snare wires 20 is a spiral metal wire, and the first and second ends 21, 22 have a spiral density (defined by spirals per inch) larger than a spiral density of the wire portion 23.

The first fixing member 30 includes a first fixing portion 31 for fixing the first end 21 of each of the snare wires 20, and a first covering portion 32 which is formed on the first fixing portion 31 by injection molding to cover the first end 21. The first covering portion 32 includes a flat first end surface 321. In this embodiment, a vertical distance 33 from the first end surface 321 of the first fixing member 30 to the first fixing portion 31 is smaller than a diameter 211 of the first end 21.

The second fixing member 40 includes a second fixing portion 41 for fixing the second end 22 of each of the snare wires 20, and a second covering portion 42 which is formed on the second fixing portion 41 by injection molding to cover the second end 22. The second covering portion 42 includes a flat second end surface 421. In this embodiment, a vertical distance 43 from the second end surface 421 of the second fixing member 40 to the second fixing portion 41 is smaller than a diameter 221 of the second end 22.

What mentioned above are the structures of the first preferred embodiment of the present invention, and the snare structure of the present invention provides the following advantages:

First of all, poisonous gas is reduced. The first fixing member 30 is provided with the first covering portion 32 which is formed on the first fixing portion 31 by injection molding to cover the first end 21, and the second fixing member 40 is provided with the second covering portion 42 which is formed on the second fixing portion 41 by injection molding to cover the second end 22. Namely, the snare wires 20 can be directly fixed to the first and second fixing members 30, 40 without welding, which prevents the generation of poisonous gas. Furthermore, the forming of the covering portions is easy and quick.

On the other hand, scratch of the drum can be prevented. The first end surface 321 of the first covering portion 32 is flat, and the second end surface 421 of the second covering portion 42 is also flat, no rough and uneven structure will appear at the connecting portions between the first and second fixing members 30, 40 and the snare wires 20, which can prevent the scratch of the lower surface of the scratch, when the snare is assembled to the drum 11.

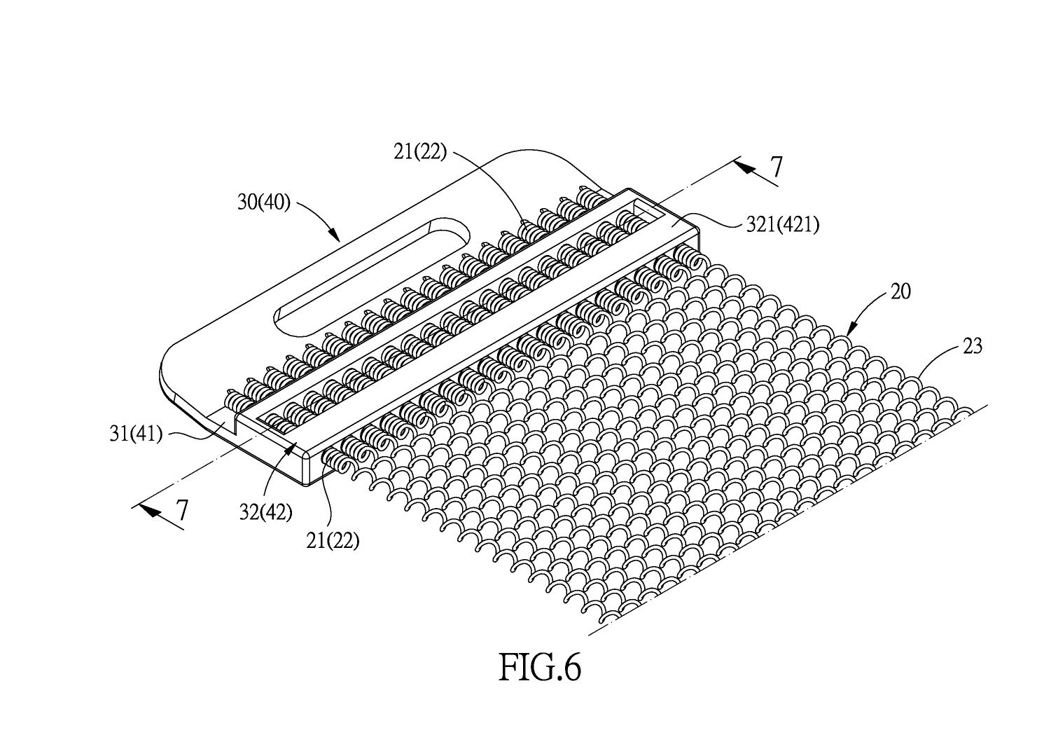

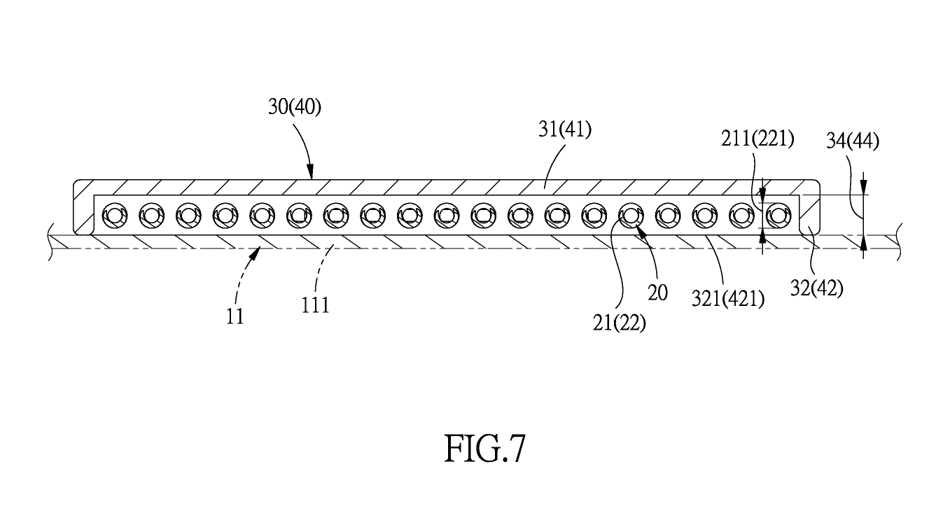

Referring to FIGS. 6 and 7, a snare structure for a drum in accordance with a second embodiment of the present invention is similar to the first embodiment, except that:

A vertical distance 34 from the first end surface 321 of the first fixing member 30 to the first fixing portion 31 is bigger than a diameter 211 of the first end 21 of the snare wires 20, and a vertical distance 44 from the second end surface 421 of the second fixing member 40 to the second fixing portion 41 is smaller than a diameter 221 of the second end 22. Therefore, no rough and uneven structure will appear at the connecting portions between the first and second fixing members 30, 40 and the snare wires 20, which can prevent the scratch of the lower surface of the scratch, when the snare is assembled to the drum 11.

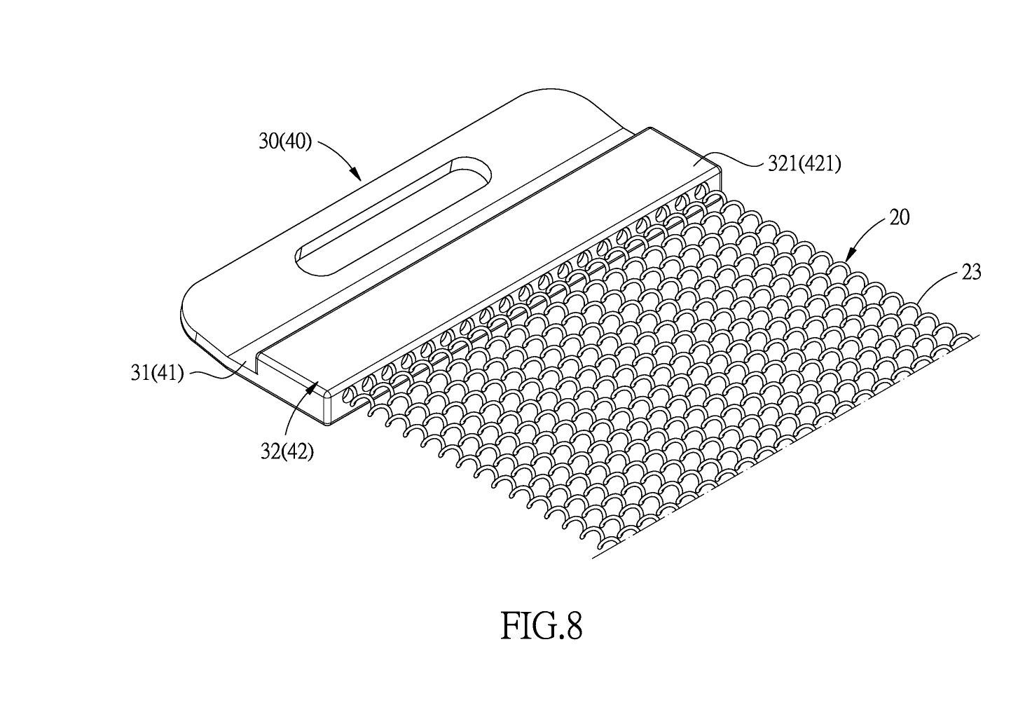

As shown in FIG. 8, in the second embodiment, the first and covering portions 32, 42 of the first and second fixing members 30, 40 also include a flat first and second end surface 321, 421, and cover the first and second ends of the snare wires 20.

While we have shown and described various embodiments in accordance with the present invention, it is clear to those skilled in the art that further embodiments may be made without departing from the scope of the present invention.

What is claimed is:

1. A snare structure for a drum comprising:
a plurality of snare wires each including a first end, an opposite second end, and a wire portion between the first and second ends;
a first fixing member including a first fixing portion for fixing the first end of each of the snare wires, and a first covering portion which is formed on the first fixing portion by injection molding to cover the first end, the first covering portion including a flat first end surface; and
a second fixing member including a second fixing portion for fixing the second end of each of the snare wires, and a second covering portion which is formed on the second fixing portion by injection molding to cover the second end, and the second covering portion including a flat second end surface.

2. The snare structure for the drum as claimed in claim 1, wherein a vertical distance from the first end surface of the first fixing member to the first fixing portion is smaller than a diameter of the first end of each of the snare wires, and a vertical distance from the second end surface of the second fixing member to the second fixing portion is smaller than a diameter of the second end of each of the snare wires.

3. The snare structure for the drum as claimed in claim 1, wherein a vertical distance from the first end surface of the first fixing member to the first fixing portion is larger than a diameter of the first end of each of the snare wires, and a vertical distance from the second end surface of the second fixing member to the second fixing portion is larger than a diameter of the second end of each of the snare wires.
